(19) United States
(12) Patent Application Publication
(10) Pub. No.: US 2025/0222364 A1
(43) Pub. Date: Jul. 10, 2025

(54) HANDHELD VIDEO GAME CONSOLE MOUNTING METHOD AND ASSEMBLY THEREOF

(71) Applicant: Brittni Weston, Eden Prairie, MN (US)

(72) Inventor: Brittni Weston, Eden Prairie, MN (US)

(21) Appl. No.: 18/408,701

(22) Filed: Jan. 10, 2024

(51) Int. Cl. A63F 13/98; A63F 13/92; F16M 11/04; F16M 13/02

(52) U.S. Cl. CPC A63F 13/98; A63F 13/92; F16M 11/041; F16M 13/02

(57) ABSTRACT

A handheld video game console securing device that includes a first connecting structure and a second connecting structure connected together by a resiliently stretchable. Each of the connecting structures includes a snap-in connecting arrangement that permits a user to snap each connecting structure into or onto a corresponding receiving portion on opposite sides of a handheld video game console where wireless controllers would usually be connected.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

Handheld video game consoles, such as the PlayStation® Portable, the Nintendo Switch®, and Steam Deck™, are very popular with consumers due to their portability, which permits a user to enjoy a video game experience virtually anywhere away from the home, such as in a vehicle, in a public space, or at another person's home. As the name indicates, the video game console is designed to be held by hand by the user. However, it may be desirable in some instances for the video game console to be temporarily mounted or placed in a standalone position, such as if the user is playing the video game for an extended period of time and/or with other players in a multiplayer game.

### (2) Description of Related Art Including Information Disclosed Under 37 CFR 1.97 and 1.98

Mounting or securing structures have been used for many years to secure video devices for entertainment to headrests and similar structures. However, many such devices for handheld video game consoles have hard plastic parts and frames that limit their use. Such plastic frames can be cumbersome to transport and difficult to install.

### BRIEF SUMMARY OF THE INVENTION

In accordance with at least one possible exemplary embodiment disclosed herein, a securing device or holding device can be used to at least temporarily attach or secure or mount a handheld video game console to a structure, such as a seat or chair or other structure. The securing device can include two connecting structures that can be affixed or connected to a handheld video game console. The connecting structures are connected together by a mounting strap, such as a strap or band or similar flexible structure. The mounting strap can be made of an elastic or resilient or cloth or fabric material. The mounting strap, in accordance with at least one possible exemplary embodiment, can be a stretchable and/or adjustable single structure or in two pieces. The mounting strap can include an adjustable clasp or buckle to permit the length of the mounting strap and the distance between the two connecting structures to be adjusted and then secured at a desired length or distance.

In order to use the securing device, the connecting structures are connected by a user to opposite ends of the handheld video game console. The handheld video game console is placed against a surface of the structure to which it is to be secured, such as the back of a headrest of a seat in an airplane or automobile. The mounting strap is then stretched around the headrest. Due to the resilient elasticity or adjustability or both of the mounting strap, the mounting strap fits completely around the head rest and secures the handheld video game console to the head rest. The handheld video game console is now temporarily mounted in an area that can be easily viewed by the user or users without the need for any user to hold the handheld video game console. The users can now play the video game using an input device, such as a wired controller or a wireless controller, such as a Bluetooth® controller. The design of the securing device permits easy and quick mounting and dismounting on virtually any headrest or similar structure, regardless of the size and/or design of the headrest.

In accordance with at least one possible exemplary embodiment disclosed herein, the connecting structures are designed to connect directly to and interface with the handheld video game console. In accordance with at least one possible exemplary embodiment disclosed herein, the connecting structures are designed to connect with a handheld video game console in the style of a Nintendo Switch™. A handheld video game console of this style generally has a main body or housing that includes the video game screen. On either end of that housing are located two removable controllers which are connected by a snap-in, quick-release connection. During handheld use, the user holds the handheld video game console by the two removable controllers. These controllers can be removed to be used as wireless controllers. When installing the securing device, the controllers can be removed, and the two connecting structures can be connected to the housing in their place using a snap-in type connection. Instead of a cumbersome plastic framework that must be connected to the outer surface of the housing, the securing device can be easily and quickly snapped onto the handheld video game console using the existing snap-in connection that is integral to the handheld video game console. Such a design provides a very easy and secure way to connect the connecting structures, and thus the securing device, to the handheld video game console, such as a Nintendo Switch® or similar device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a securing device according to an embodiment of the disclosure.

FIG. 2 is a front view of the securing device shown in FIG. 1.

FIG. 3 is a rear view of the securing device shown in FIG. 1.

FIG. 4 is a top view of the securing device shown in FIG. 1.

FIG. 5 is a side view of the securing device shown in FIG. 1.

FIG. 6 is a side view of the securing device shown in FIG. 1.

FIG. 7 is a side view of the securing device shown in FIG. 1.

FIG. 8 is a close-up perspective view of a portion of the securing device shown in FIG. 1.

FIG. 9 is a cross-section view of the portion of the securing device shown in FIG. 8.

FIG. 10 is a front perspective view of a handheld video game console according to the prior art.

FIG. 11 is a front perspective view of the securing device shown in FIG. 1 being installed on a handheld video game console.

FIG. 12 is a front perspective view of the securing device shown in FIG. 1 installed on a handheld video game console.

FIG. 13 is a rear perspective view of the securing device shown in FIG. 1 installed on a handheld video game console.

FIG. 14 shows the securing device shown in FIG. 1 installed secured to a headrest of a seat of an airplane.

### DETAILED DESCRIPTION OF THE INVENTION

With reference now to the drawings, a new securing device embodying the principles and concepts of an embodiment of the disclosure and generally designated by reference numeral 10 will be described.

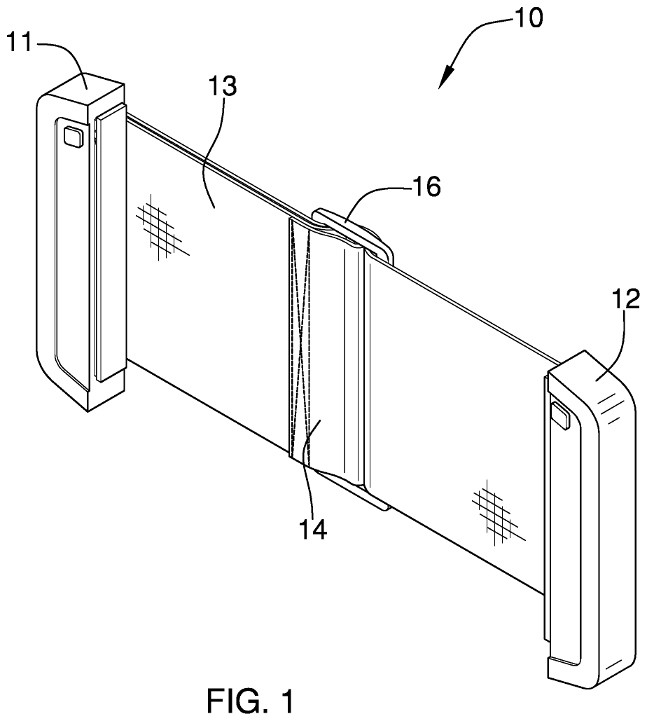

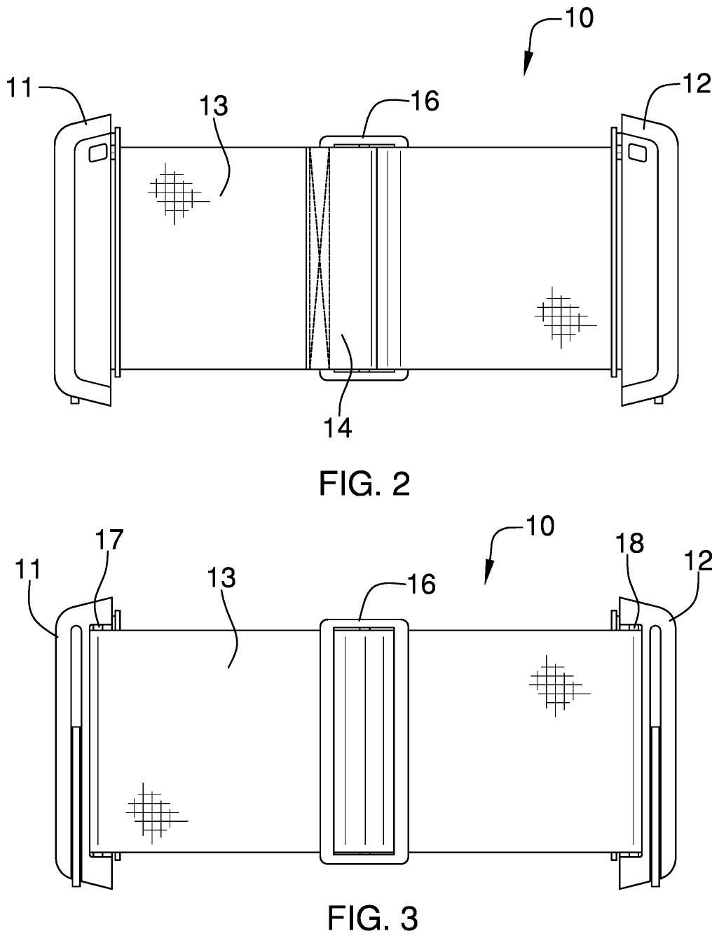

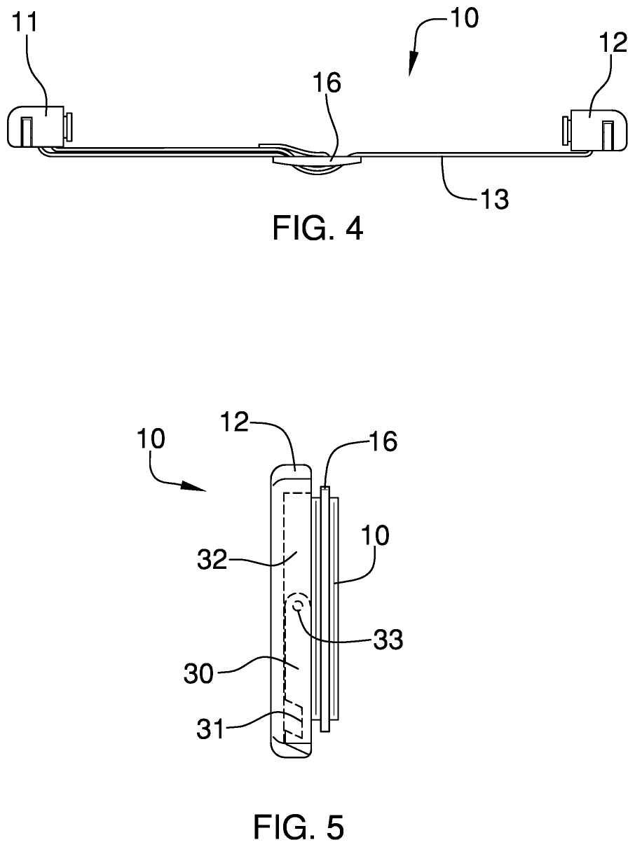

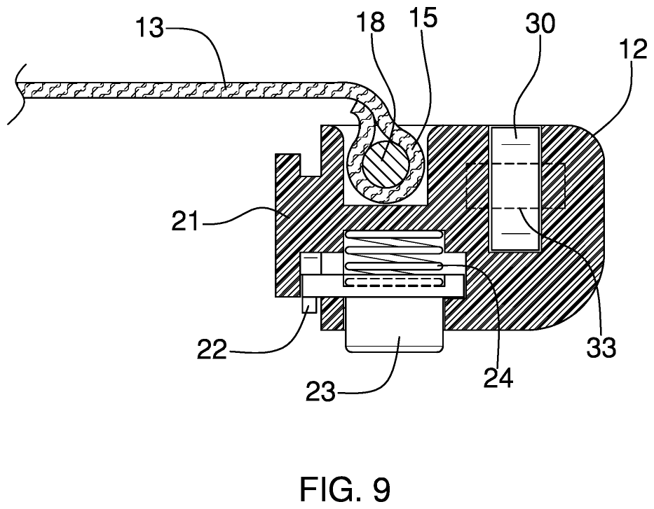

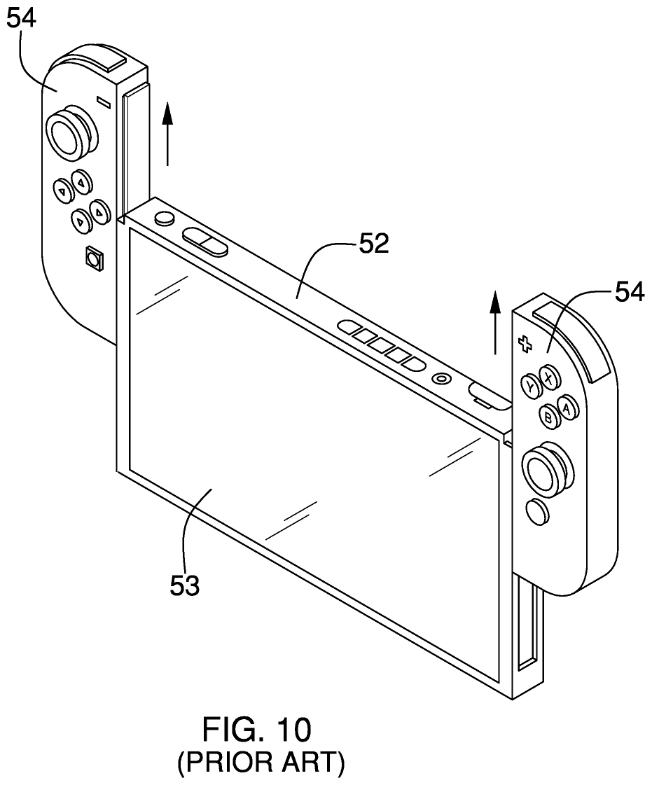

As best illustrated in FIGS. 1 through 14, the securing device 10 generally comprises a first connecting structure 11 and a second connecting structure 12 that can be affixed or connected to a handheld video game console 50 (see FIGS. 10-14). The connecting structures 11, 12 are connected together by a mounting strap 13, such as a strap or band or similar flexible structure. The mounting strap 13 can be made of an elastic or resilient or cloth or fabric material. The mounting strap 13 comprises an adjustable clasp 16 or buckle to permit adjustment of the distance between the two connecting structures 11, 12 to a desired length corresponding to the dimensions or size of a headrest or structure to which the securing device 10 is to be attached. The mounting strap 13, as shown in FIG. 1, comprises a first end portion 14 and a second end portion 15 (see FIG. 9). The first end portion 14 is in the form of a loop that is wrapped through and around a central portion of the clasp 16. The first end portion 14 is created by attaching or stitching an end of the mounting strap 13 to a portion of the mounting strap 13 itself. As shown in FIG. 9, the second end portion 15 is also in the form of a loop placed around a second post 18 located in the second connecting structure 12. As best seen in FIG. 3, the first connecting structure 11 comprises a first post 17. The mounting strap 13, starting at the first end portion 14, wraps around the first post 17, doubles back or overlaps on itself (see FIG. 1), passes through the clasp 16 (see FIG. 3), and then ends at the second end portion 15. By adjusting the position of the clasp 16, the distance between the connecting structures 11, 12 can be increased or decreased as desired to permit installation of the securing device 10 on different headrests or similar structures of differing sizes and configurations.

In order to use the securing device 10, the connecting structures 11, 12 are connected by a user to opposite ends of the handheld video game console 50, which connection is discussed further below. The handheld video game console 50 is placed against a surface of the structure to which it is to be secured. As seen in FIG. 14, the securing device 10 can be mounted on or connected to a headrest 61 of a seat 60 in an airplane or automobile. The mounting strap 13 is then stretched around the headrest. Due to the elasticity or adjustability or both of the mounting strap 13, the mounting strap 13 fits completely around the headrest 61 and secures the handheld video game console 50 to the headrest 61. The handheld video game console 50 is now temporarily mounted in an area that can be easily viewed by the user or users without the need for any user to hold the handheld video game console 50. As shown in FIG. 14, the handheld video game console can now be controlled using a wireless controller 51, such as a Bluetooth® controller, which is operatively connected to the handheld video game console by a wireless signal.

In accordance with at least one possible exemplary embodiment disclosed herein, the connecting structures 11, 12 are designed to connect directly to and interface with the handheld video game console. In the embodiment shown in FIGS. 1-14, the connecting structures 11, 12 are designed to connect with a handheld video game console in the style of a Nintendo Switch™. As shown in FIG. 10, the handheld video game console of this style generally has a main body or housing 52 that includes the video game screen 53. On either end of that housing 52 are located two removable wireless controllers 54 which are connected by a snap-in, quick-release connection. During handheld use, the user holds and utilizes the handheld video game console by the two removable controllers 54. These controllers 54 can be removed to be used as wireless controllers 54. When installing the securing device 10, the controllers 54 can be removed, and the two connecting structures 11, 12 can be connected to the housing 52 in their place using a snap-in type connection. Instead of a cumbersome plastic framework that must be connected to the outer surface of the housing 52, the securing device 10 can be easily and quickly snapped onto the handheld video game console using the existing snap-in connection that is integral to the handheld video game console. Such a design provides a very easy and secure way to connect the connecting structures 11, 12, and thus the securing device 10, to the handheld video game console, such as a Nintendo Switch® or similar device.

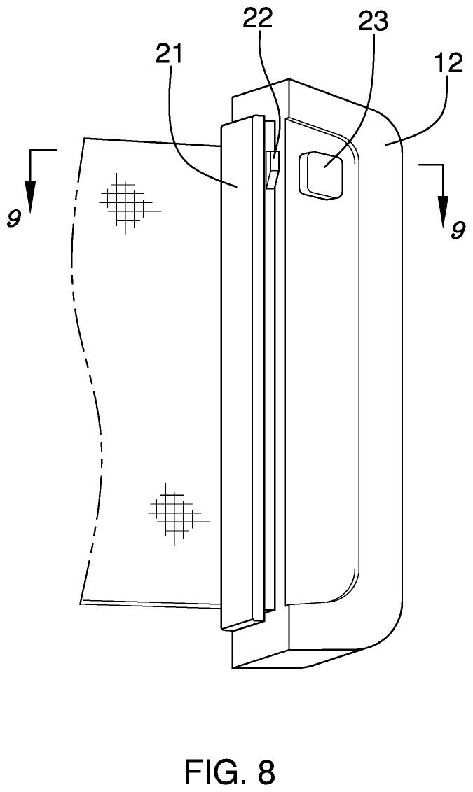

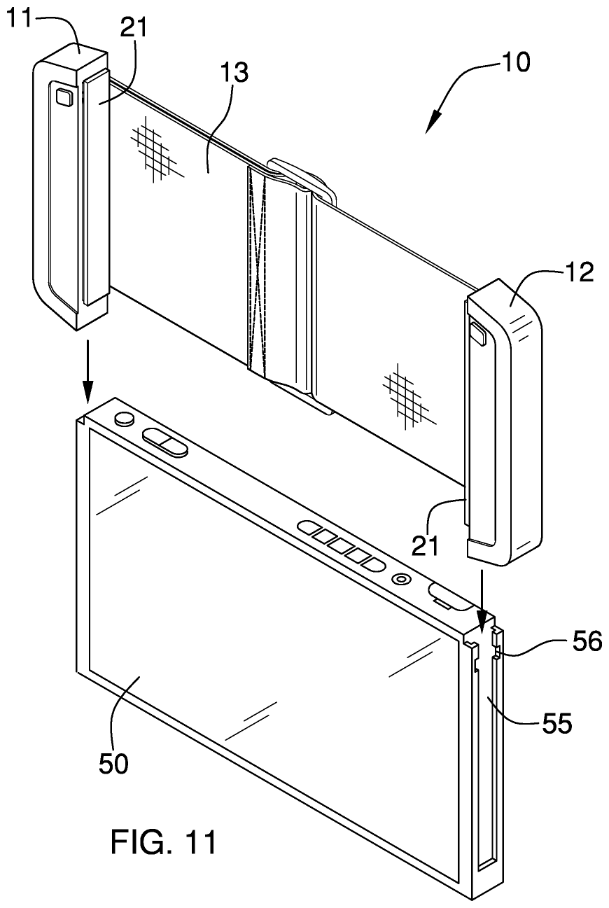

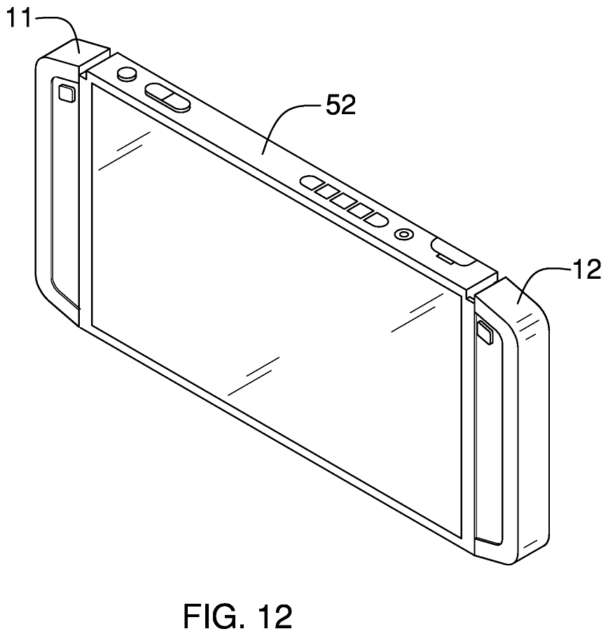

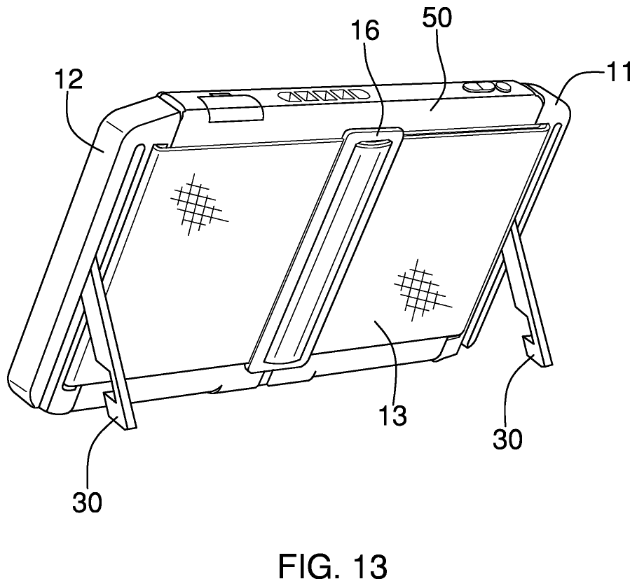

The structure of the snap-in connection and how it interacts with the handheld video game console is best seen in FIGS. 8, 9 and 11. As seen in FIG. 11, the handheld video game console has a connecting slot 55 or receptacle on either side, each comprising a recess 56 or notch or shoulder area. Each of the connecting structures 11, 12 comprises a corresponding flange 21 or projection designed to slide into a retaining engagement with the connecting slot 55. FIG. 8 shows a close-up view of the flange 21 of the second connecting structure 12. In addition to the flange 21, each connecting structure 11, 12 comprises a snap-in projection 22 or locking tab that is beveled and designed to engage with a corresponding recess 56 to lock the connecting structures 11, 12 in place on the housing 52 of the handheld video game console. A button 23 is operatively connected to the projection 22 to allow a user to retract the projection 22 to permit removal or disengagement of the connecting structures 11, 12 from the handheld video game console. As seen in FIG. 9, which is a cross-sectional view of FIG. 8, the button 23 is connected to a spring 24 which biases the button 23 outwardly. When the button 23 is pressed, the spring 24 is compressed and the projection 22 is retracted. During installation of the securing device 10 on the handheld video game console, as the connecting structures 11, 12 are slid into engagement, the beveled design of the projection 22 allows the projection 22 to engage with the connecting slot 55. The biasing force of the spring 24 is overcome and the projection 22 is gradually pressed inwardly by the walls of the connecting slot 55. However, when the projection 22 enters the recess 56, the projection 22 is released and the spring 24 presses the projection 22 into the recess 56 to create a snap-in or snap-fit connection. The full connection of the securing device 10 to the handheld video game console is shown in FIG. 12.

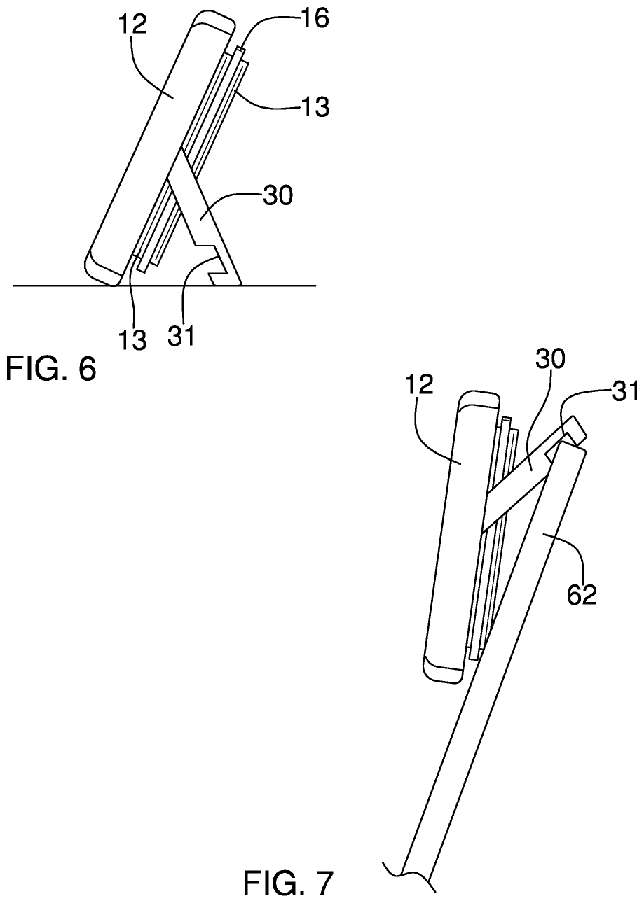

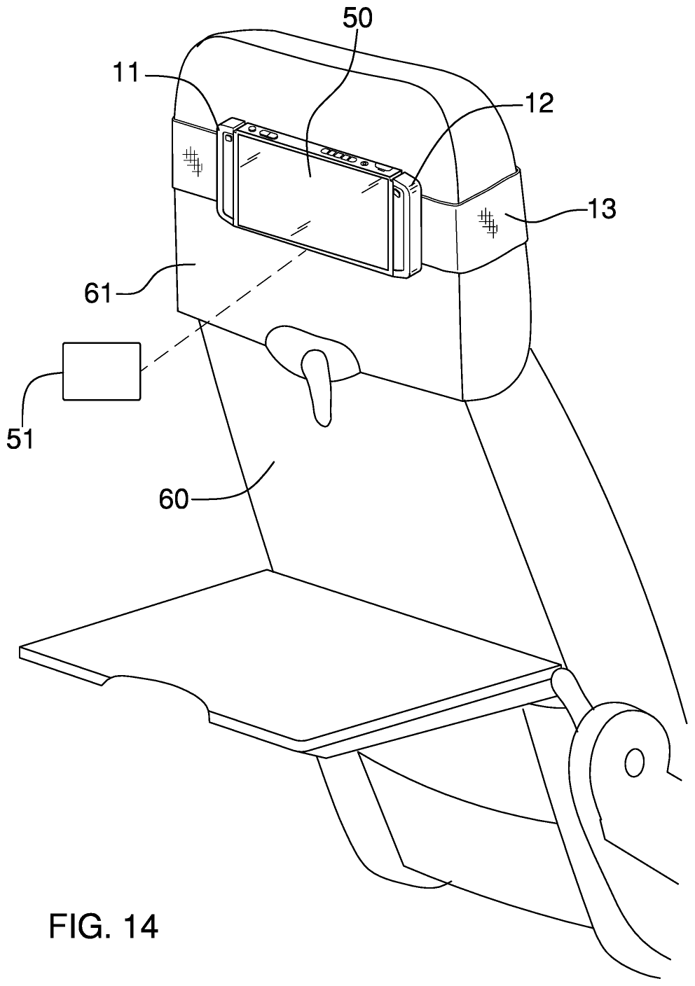

In at least one possible exemplary embodiment, the securing device 10 comprises a kickstand 30 or support leg, shown in FIGS. 5, 6, 7, 9, and 13. Either or both of the connecting devices 11, 12 comprises its own kickstand 30. As shown in FIG. 13, two kickstands 30 are shown projecting out of the connecting structures 11, 12. These kickstands 30 allow the handheld video game console to be placed on a flat surface, as shown in FIG. 6. In at least one possible exemplary embodiment, the kickstand 30 comprises a recess portion 31, which, as shown in FIG. 7, can allow a user to hang the handheld video game console from a structure 62, such as the back of a seat or chair. When not in use, the kickstand 30 is stored in slot 32 or recess in its connecting structure 11, 12. The kickstand 30 is pivotable about an axle 33 to any angular position, with respect to its connecting structure 11, 12, in the range of zero to about 180 degrees, and fixable at any of the angles within that range, in accordance with at least one possible exemplary embodiment. The axle 33, in accordance with at least one possible exemplary embodiment, has a step design in that the kickstand 30 is fixable at certain predetermined angles most suitable for resting on a flat surface or hanging from a vertical planar structure.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A handheld video game console securing device comprising:
a first connecting structure and a second connecting structure each being removably connectable to opposite sides of a handheld video game console in place of handheld video game console wireless controllers;
a mounting strap connecting together said first and second connecting structures, said mounting strap being resiliently stretchable, said mounting strap being extendable around a structure on which a handheld video game is to be mounted; and
each of said first and second connecting structures comprising a snap-in connecting arrangement configured to snap into a corresponding receiving portion of a housing of a handheld video game console where wireless controllers are to be connected.

2. The handheld video game console securing device according to claim 1, wherein:
said handheld video game console securing device comprises a clasp disposed on said mounting strap and configured to permit adjustment of the length of said mounting strap between said first and second connecting structures to a desired length corresponding to a size of a structure; and
said mounting strap is configured to be tightened and locked in place by said clasp about a structure.

3. The handheld video game console securing device according to claim 2, wherein:
said mounting strap comprises a first end portion and a second end portion;
said first end portion comprises a loop wrapped through and around a central portion of said clasp;
said second end portion is attached to said second connecting structure; and
said mounting strap is disposed, starting at the first end portion, to pass into, through, and out of said first connecting structure, double back or overlap on itself, pass through said clasp, and end at said second end portion in said second connecting structure.

4. The handheld video game console securing device according to claim 3, wherein said snap-in connecting arrangement comprises:
a flange configured to slide into a retaining engagement in a connecting slot of a handheld video game console; and
a snap-in projection configured to engage with a corresponding recess of the connecting slot to lock its connecting structure in place on a housing of the handheld video game console.

5. The handheld video game console securing device according to claim 4, wherein:
said snap-in connecting arrangement comprises a biasing device configured to exert a pressing force on said snap-in projection;
said snap-in projection comprises a beveled surface configured to engage with the connecting slot of a handheld video game console upon installation of said handheld video game console securing device on the handheld video game console, and thereby overcome said pressing force of said spring and press said snap-in projection inwardly into its connecting structure; and
said spring is configured to press said snap-in projection into the corresponding recess upon said snap-in projection being moved into the corresponding recess to create a locking engagement between its connecting structure and the housing of the handheld video game console.

6. The handheld video game console securing device according to claim 5, wherein said snap-in connecting arrangement comprises a button operatively connected to said snap-in projection and configured to be pressed by a user to retract said snap-in projection to permit removal or disengagement of said connecting structures from the handheld video game console.

7. The handheld video game console securing device according to claim 6, wherein:
said first connecting structure comprises a first post;
said second connecting structure comprises a second post;
said mounting strap is configured and disposed to wrap around said first post in an adjustable manner; and
said second end portion of said mount strap comprises a loop wrapped around said second post in a fixed manner.

8. The handheld video game console securing device according to claim 7, wherein said mounting strap comprises a resiliently elastic material.

9. The handheld video game console securing device according to claim 8, wherein:
at least one of said first and second connecting structures comprises a kickstand;
said kickstand is stored in a slot in its connecting structure; and
said kickstand is pivotable by hand out of said slot and fixable at an angle with respect to a handheld video game console to permit a user to place the handheld video game console in a standalone manner on a surface.

10. The handheld video game console securing device according to claim 9, wherein said kickstand comprises a recess portion configured to allow a user to hang the handheld video game console from a vertical planar structure comprising a seat or a chair or a similar structure.

11. The handheld video game console securing device according to claim 10, wherein in combination with a wireless controller configured to control a handheld video game console mounted by the handheld video game console securing device.

12. The handheld video game console securing device according to claim 1, wherein said snap-in connecting arrangement comprises:
a flange configured to slide into a retaining engagement in a connecting slot of a handheld video game console; and
a snap-in projection configured to engage with a corresponding recess of the connecting slot to lock its connecting structure in place on a housing of the handheld video game console.

13. The handheld video game console securing device according to claim 1, wherein said mounting strap comprises a resiliently elastic material.

14. The handheld video game console securing device according to claim 1, wherein:
at least one of said first and second connecting structures comprises a kickstand;
said kickstand is stored in a slot in its connecting structure; and
said kickstand is pivotable by hand out of said slot and fixable at an angle with respect to a handheld video game console to permit a user to place the handheld video game console in a standalone manner on a surface.

15. The handheld video game console securing device according to claim 14, wherein said kickstand comprises a recess portion configured to allow a user to hang the handheld video game console from a vertical planar structure comprising a seat or a chair or a similar structure.

16. The handheld video game console securing device according to claim 1, wherein in combination with a wireless controller configured to control a handheld video game console mounted by the handheld video game console securing device.

17. A method of securing a handheld video game console to a structure using a handheld video game console securing device, said method comprising the steps of:
disconnecting handheld video game console wireless controllers from opposite sides of said handheld video game console;
connecting a first connecting structure and a second connecting structure to said opposite sides of said handheld video game console in place of said handheld video game console wireless controllers by snapping a snap-in connecting arrangement into a corresponding receiving portion of a housing of said handheld video game console;
adjusting a clasp of a mounting strap connecting said first and second connecting structures and thereby adjusting the length of said mounting strap between said first and second connecting structures to a desired length corresponding to the dimensions or size of the headrest or similar structure to which said handheld video game console securing device is to be attached; and
placing said handheld video game console against the headrest or similar structure and said mounting strap around the headrest or similar structure.

18. The method of securing a handheld video game console securing device according to claim 17, wherein said step of connecting said snap-in connecting arrangement comprises:
sliding a flange of said connecting arrangement configured to slide into a retaining engagement in a connecting slot of said handheld video game console; and
inserting a spring-loaded snap-in projection of said connecting arrangement into a corresponding recess of said connecting slot.

19. The method of securing a handheld video game console securing device according to claim 18, wherein said method further comprises pressing a button of said snap-in connecting arrangement, operatively connected to said snap-in projection, and retracting said snap-in projection to permit removal or disengagement of said connecting structures from said handheld video game console.

20. A method of securing a handheld video game console in a standalone position using a handheld video game console securing device, said method comprising the steps of:
disconnecting handheld video game console wireless controllers from opposite sides of said handheld video game console;
connecting a first connecting structure and a second connecting structure to said opposite sides of said handheld video game console in place of said handheld video game console wireless controllers, by snapping a snap-in connecting arrangement into a corresponding receiving portion of a housing of said handheld video game console;
pivoting kickstands out of a slot in each of said first and second connecting structures and fixing said kickstands at an angle; and
one of (A) and (B):
(A) placing said handheld video game console on a substantially horizontal planar surface propped up by said kickstands positioned at an angle less than 90 degrees with respect to the handheld video game console; and
(B) hanging said handheld video game console on a substantially vertical planar structure from a recess in said kickstands positioned at an angle greater than 90 degrees with respect to said handheld video game console.
